(19) United States
(12) Patent Application Publication
(10) Pub. No.: US 2016/0075394 A1
(43) Pub. Date: Mar. 17, 2016

(54) Motorcycle Handlebar Riser Accessory Device

(71) Applicant: Kirt Gardiner, Kent, WA (US)

(72) Inventor: Kirt Gardiner, Kent, WA (US)

(21) Appl. No.: 14/717,409

(22) Filed: May 20, 2015

Related U.S. Application Data
(60) Provisional application No. 62/050,262, filed on Sep. 15, 2014.

(51) Int. Cl. B62K 21/22

(52) U.S. Cl. CPC B62K 21/22

(57) ABSTRACT

A motorcycle handlebar riser assembly and novelty accessory is provided. The assembly comprises a pair of riser members that support a handlebar therebetween and connect the handlebar to the upper triple tree of a motorcycle. Along the length of each riser member is a spring perch member and a faux suspension spring. The spring is disposed between at least one perch and the lower end of the riser member, which affixes to the triple tree. In this way, the risers support the handlebar and display a faux suspension spring thereover. The risers include a length with an aperture and removable cap at one end, and a lower end that is configured to be received by a triple tree and be secured thereto.

### CROSS REFERENCE TO RELATED APPLICATION

This application claims the benefit of U.S. Provisional Application No. 62/050,262 filed on Sep. 15, 2014, entitled “ Spring Handlebar Risers.” The above identified patent application is herein incorporated by reference in its entirety to provide continuity of disclosure.

### BACKGROUND OF THE INVENTION

1. Field of the Invention

The present invention relates to motorcycle handlebar assemblies and devices that improve or alter the appearance of a motorbike. More specifically, the present invention relates to a novelty accessory for a motorcycle in which a pair of faux spring elements are supported by handlebar elements, whereby the vertical supports of the handle bar elevates the existing handlebars and supports the spring elements to update the appearance and style of the motorcycle suspension.

Many motorcyclists enjoy customizing and personalizing their motorcycles. Various accessories are available that can be installed or fitted onto a motorcycle to update its style, change its appearance, or improve its performance. Many of these accessories are stylistic, including tassels and other novelties, chrome parts, carbon fiber parts and the like. Others are more performance orientated, and include items such as updated handlebars, foot pegs, updated mirrors, and other functional elements. While motorcycle accessories can range in price and can quickly become expensive options, many motorcyclists pride themselves on having a unique and personalized ride that is distinguished from models delivered from the factory.

The present invention is related to a handlebar assembly that is configured to support a pair of novelty accessories that update the look of the motorcycle suspension. Conventional front suspension systems for motorcycles comprise a pair of fork tubes that are secured in a parallel arrangement using an upper and lower fork tree, or triple tree. The triple tree rotatably secures the fork tubes to the frame of the motorcycle, while the lower ends of the forks secure to the front wheel using a front axle. The fork tubes support the suspension springs and dampers internally within walled tubes, whereby the spring is not visible and the damper piston moves in and out of the fork tube.

While front forks are functional and highly sophisticated components, they lack an external look or flashiness that accompanies the rear suspension, which generally includes one or more exposed springs coiled over one or more dampers. The present invention contemplates a new handlebar assembly that includes novelty suspension springs along the exterior thereof, which are configured to update the look of the motorcycle suspension to provide an exposed spring look.

More specifically, the present invention contemplates a combination handlebar assembly and novelty accessory. The assembly comprises a pair of riser elements that function as vertical members supporting a handlebar therebetween. The risers may be integrally affixed or clamped to the handlebar, and provide an elongated member disposed above the motorcycle upper triple tree. The risers are affixed to the upper triple tree and support a pair of faux motorcycle springs therealong. A first and second spring perch may be provided to stabilize the springs, while the risers are functional and support the handlebar during operation of the motorcycle. The springs are not loaded between the triple tree and upper spring perch, therefore the exterior spring elements provide a purely decorative update to the front suspension once installed.

2. Description of the Prior Art

Devices have been disclosed in the prior art that relate to handlebar riser assemblies. These include devices that have been patented and published in patent application publications. These devices generally relate to functional risers that include various means of attaching the riser to a motorcycle triple tree, and furthermore risers with specific adjustability. The present invention provides a riser assembly that is configured to elevate an existing set of handlebars, while also supporting a pair of faux motorcycle springs as an exterior accessory. The following is a list of devices deemed most relevant to the present disclosure, which are herein described for the purposes of highlighting and differentiating the unique aspects of the present invention, and further highlighting the drawbacks existing in the prior art.

U.S. Pat. No. 7,344,329 to Hutchinson discloses a handle bar riser assembly that supports adjustment of the handlebar location relative to the triple tree, whereby the risers can adjust their overall length. The risers affix to the steering assembly and are lockable in place. The risers can be adjusted so the user can operably set the desired height of the handlebars. The Hutchinson provides a handlebar riser assembly with enhanced functionality, whereby adjustability is provided. The present invention, by contrast, contemplates a standard set of risers that support a handlebar at a defined height from a triple tree, while also supporting accessory springs along the exterior lengths thereof. The present invention is directed to functional risers with support for a defined accessory item.

U.S. Patent Publication No. 2010/0011904 to Flanders discloses a simple riser assembly for motorcycle handlebars, in which an intermediate shaft is placed between the handlebar clamps and the steering assembly. While elevating handlebars above the position provided by the manufacturer, the Flanders device fails to contemplate the novelty aspects of the present invention; notably, the external springs and spring supports.

U.S. Patent Publication No. 2003/0084746 to Cutsforth discloses a handlebar mounting apparatus that allows for rotational adjustment of the handlebars once installed. The apparatus comprises a pair of mounts with selective, eccentric rotation to allow for height and position adjustment of the handlebar in relation to the vehicle. Cutsforth, while providing risers having adjustment capability, fails to contemplate one that supports faux springs along their structure. Cutsforth is typical of sophisticated riser assemblies that support a method of adjustment, yet fail to anticipate the novelty spring accessories of the present invention.

U.S. Pat. No. 7,685,904 also to Cutsforth discloses another position adjustable handlebar riser assembly. The assembly comprises a pair of mounts that include an elongated slot and a pair of second members that are slidably and rotatably engaged with the slots using a fastener through each. The slots allow the second members to pivot and to be elevated relative to the mounts. The mounts secure to the steering system of the vehicle, while the second members secure the handlebar. As with the aforementioned devices, while the Cutsforth device provides for position adjustment, the device fails to anticipate the elements of the present invention.

The present invention provides a functional handlebar riser device for a motorcycle steering system, while also providing a means to support an accessory item therefrom. Specifically, a set of handlebar risers is provided that include a spring perch and a set of faux springs to update the look of the motorcycle suspension system, whereby external springs are displayed. The springs are purely for decorative and novelty purposes, while the risers themselves can be sized to support a handlebar at a desired height.

Overall, the present invention diverges significantly in design elements from the prior art, and consequently it is clear that there is a need in the art for an improvement to existing motorcycle accessory devices. In this regard the instant invention substantially fulfills these needs.

### SUMMARY OF THE INVENTION

In view of the foregoing disadvantages inherent in the known types of motorcycle handlebar risers now present in the prior art, the present invention provides a new handlebar riser and novelty device in which can be utilized for positioning the handlebars of a motorcycle in a desired location while support decorative suspension springs as a novelty accessory.

It is therefore an object of the present invention to provide a new and improved handlebar riser assembly that has all of the advantages of the prior art and none of the disadvantages.

It is another object of the present invention to provide a handlebar riser assembly that supports a handlebar in two locations and provides an offset between the upper triple tree of the motorcycle suspension and the handlebar location.

Another object of the present invention is to provide a handlebar riser assembly that can be used to clamp a number of different handlebar configurations, or alternatively comprise a set of risers affixed to a specific handlebar assembly.

Yet another object of the present invention is to provide a handlebar riser assembly that includes at least one spring perch that supports an end of a faux motorcycle suspension spring, which is supported along the length of the riser and along the exterior thereof.

Another object of the present invention is to provide a handlebar riser assembly that can be used generically on most existing motorcycles using a triple tree to secure the front spring fork tubes.

A final object of the present invention is to provide a handlebar riser assembly that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the handlebar riser of the present invention.

FIG. 2 shows a view of the handlebar riser assembly of the present invention in a working state, as well as a close-up view of its installation onto an upper triple tree.

FIG. 3 shows a perspective view of another embodiment of the handlebar riser of the present invention.

### DETAILED DESCRIPTION OF THE INVENTION

Reference is made herein to the attached drawings. Like reference numerals are used throughout the drawings to depict like or similar elements of the handlebar riser assembly of the present invention. For the purposes of presenting a brief and clear description of the present invention, the preferred embodiment will be discussed as used for positioning the handlebars of a motorcycle in a desired location relative to a triple tree, while also supporting a set of faux motorcycle suspension springs therealong. The figures are intended for representative purposes only and should not be considered to be limiting in any respect.

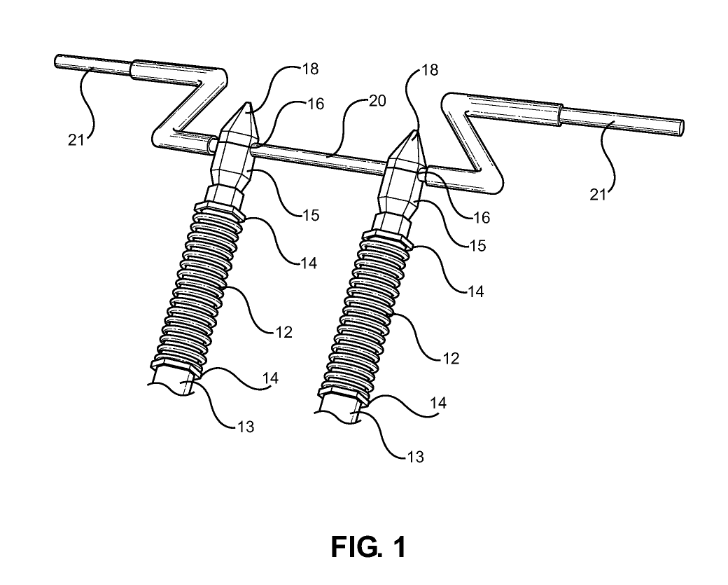

Referring now to FIG. 1, there is shown a first embodiment of the handlebar riser assembly of the present invention. The handlebar riser assembly comprises a first and second riser bar 13 that is configured to be supported by the upper triple tree of a motorcycle front suspension and provide support for couplers 15 disposed along the upper ends of the riser bars 13. The riser bars 13 include an upper end, a lower end, and an elongated length. The lower end is received by a triple tree and clamped thereto. The upper end comprises a handlebar coupler 15, which supports a motorcycle handlebar 20 along its length at a discrete location above the triple tree. The pair of riser bars 13 elevates the handle bar 20 above the triple tree a desired height, based on the elongated length chosen for the riser bars 13.

The riser bar couplers 15 each comprise a pair of members that form a handlebar aperture 16 therethrough when joined. The couplers 15 are preferably a removable clamping portion 18 that is fastened to the upper portion of the riser bar 15, whereby the upper portion of the riser bar includes a half-moon section and the removable clamping portion 18 includes a second half-moon section that forms the rounded handlebar aperture when the two are joined. This joint secures the handlebar 20 in position, whereby the handlebar 20 will not slide relative to the handlebar aperture 16 when the clamping portion 18 is securely fastened thereto.

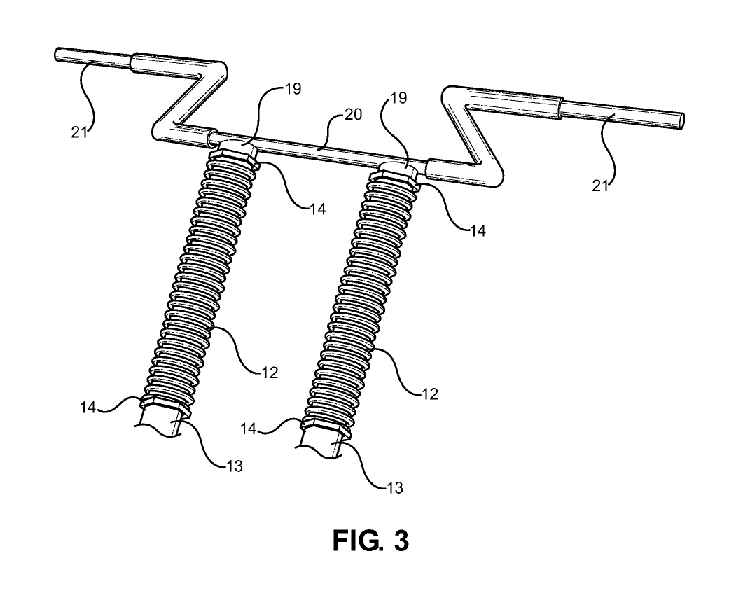

The handlebar risers clamp the handlebar 20 along an inner portion of its length, whereby the outer grip portions 21 of the handlebar are disposed along the outer sides of the riser bars 13 and in a natural position for the rider's hands. The exact shape and configuration of the handlebar 20 may take on several different designs. Moreover, the handlebar 20 and the handlebar riser bars 13 may be a unitary structure (See FIG. 3) as opposed to a pair of separable risers 13. The unitary embodiment does not require the use of removable clamping portions 18 to grip an independent handlebar member, but rather relies on a welded connection between the riser bars 13 and the handlebar 20 to maintain the handlebar position at a desired height.

Along the length of the riser bars 13 and below the upper portion thereof is at least one spring perch 14. The spring perch 14 comprises a ledge that is suitable for securing the flat upper or lower portion of a coil spring 12 disposed along the length of the riser bar 13. The coil spring is positioned around the exterior of the riser bar 13 and extends along its length. The spring 12 along each riser bar 13 is a faux coil spring that is supported between the spring perches 14 and the upper triple tree of the motorcycle, whereby the springs 12 provide a decorative accessory that updates the look of the motorcycle front end. The spring 12 can abut directly against the triple tree, or alternatively the spring 12 can be positioned between an upper and lower spring perch 14.

The springs 12 are spring elements having a spring rate, a free length, and an open interior. The open interior has an inner diameter sized to receive a riser bar 13 therethrough without interference and without contact therewith. The inner diameter of the springs 12 forms an open cylindrical volume within the spring interior that receives the riser bars 13 therein. The free length of the springs 12 are preferably substantially equal to the length of the riser bars 13 when the riser bars 13 are affixed to the upper triple tree of the front suspension. The spring 12 therefore places minimal force on the triple tree or the spring perches 14 once installed, as the distance between the spring perches 14 and triple tree does not change once the riser bars have been installed thereto, and the free length of the spring is substantially equal to the separation between the perch and the triple tree.

To supplement this, the spring constant of the springs 12 is preferably minimal to the extent that the chosen height of the handle bar 20 relative to the triple tree will not generate excessive force on the triple tree or the spring perches 14, particularly if the spring abuts against the triple tree and the handlebar is not 20 sufficiently offset from the triple tree such that the spring is partially compressed. At the same time, the spring will not “float” or vibrate along the length of the riser bars 13 after installation, particularly while the motorcycle is changing momentum or if the motorcycle exhibits significant vibrations while riding or idling. It is not desired to disclose the exact spring constant, but rather to recognize that the spring constant should allow for minor compression of the springs during installation (in the event the triple trees are closer to the upper spring perch 14 than the free length of the springs allow, or the distance between the upper and lower spring perch 14 partially compresses the spring 12). Any minor compression does not apply significant load on the triple trees or spring perches 14 in the process. At the same time, the spring constant should be sufficient to prevent vibration or movement after installation, including spinning motion of the springs once installed. The spring perches 14 may also prevent such rotation.

The spring perches support the ends of each spring 12 and prevent lateral or rotational movement of each spring 12 around the riser bars 13. The upper and lower ends of each spring 12 preferably include a flat coil portion that provides a flat plane at each end, with the flat ends being parallel to one another. Therefore, the springs 12 stand vertically when positioned on a flat surface with either end placed against the flat surface. Each spring perch 14 is an element that is formed to accept the outermost coil of each end of the spring 12. One skilled in the art of suspension design would readily recognize a suitable configuration for the perch. Examples include elastomeric members, those with specific grooves to accept and maintain the outermost coil of the spring, flanges that retain the inner diameter of the spring, and others. The spring perch may be integral to the riser bars 13, or alternatively may be separately attachable structures. In yet another embodiment, the spring perches may be foregone and the upper end of the springs 12 may bear against the handlebar 20 itself, whereby the height of the spring 12 supports this embodiment.

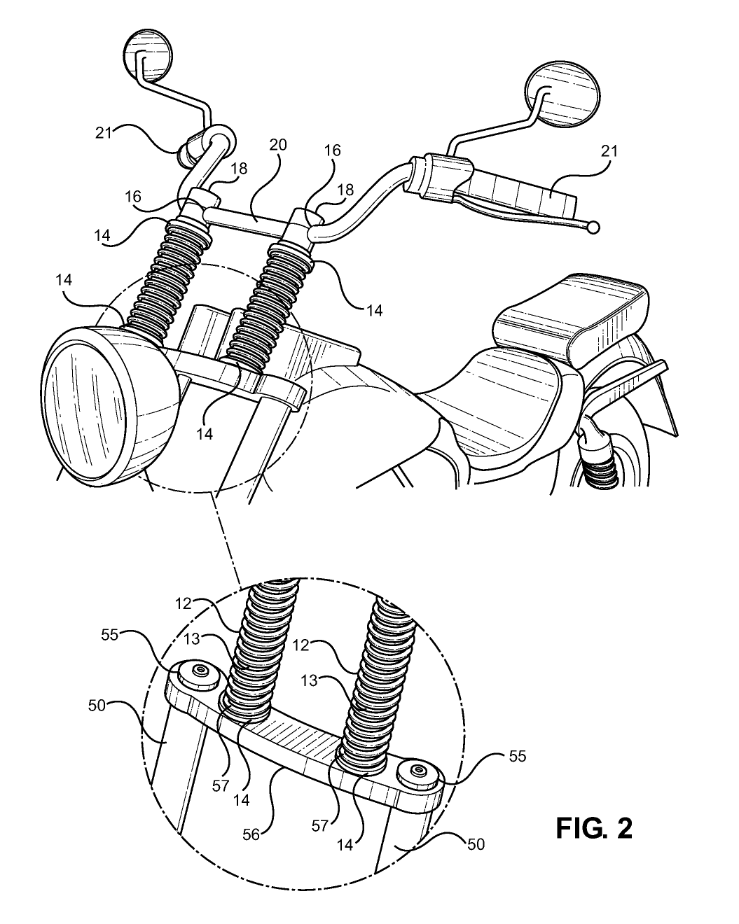

Referring now to FIG. 2, there is shown a view of the handle bar riser assembly of the present invention in a working state, secured to the upper triple tree 56 of the motorcycle and supporting a handlebar 20 along an opposite end. The riser bars 13 secure to the triple tree 56 at a pair of riser locations 57. The locations may include apertures or specific joints for securing the lower end of the riser bars 13, depending upon design of the motorcycle. The springs 12 surround the riser bars and are supported between the spring perches or between an upper spring perch and the triple tree.

When installing the assembly, the riser bars 13 secure to the triple tree 56 in the same position and in the same manner as the handlebar attachments provided by the original equipment manufacturer. These positions 57 are generally inboard of the spring fork tube 50 locations, which are disposed long the outer ends 55 of the triple tree 56. The riser bars 13 are supported along their lower end by the triple tree 56, while the upper end of the riser bars 13 is either permanently affixed to clamped to the handlebar 20. The clamped embodiment, as shown in FIG. 2, includes a removable clamping portion 18 along the upper end of the riser bar, whereby the clamping portion 18 of each riser bar 13 secures the handlebar 20 in place at two locations along its length, inboard of the grip portions 21 thereof.

Referring now to FIG. 3, there is shown an alternative configuration of the present invention, whereby the riser bars 13 are permanently affixed to the handlebar 20. The upper end 19 of the riser bar is welded or otherwise permanently attached to the handlebar 20. This provides a unitary assembly comprising a handlebar member 20, a pair of riser bar members 20 that are affixed thereto in a substantially perpendicular relationship, and the faux spring 12 and perch 14 portions along the riser bar members 20. The assembly affixes to the triple tree of the motorcycle in the same fashion as the removable embodiment (FIG. 1), and the spring 12 assembly is also the same.

Overall, the present invention provides a pair of springs that can be utilized to replace and/or work in conjunction with existing handlebars. The pair of handlebar risers enable a user to personalize their bike and increase the aesthetics of the motorcycle by supporting a pair of faux springs therefrom, which are exposed and positioned along the exterior of the riser bar members. Once installed, the assembly provides an outer appearance of a front suspension with exposed springs. The assembly provides a faux suspension component, which updates the look of the motorcycle front end. The present invention provides a unique, retro appearance reminiscent of motorcycles produced in the 1930s and 1940s, which included exposed spring forks disposed on the front forks. Thus, the device disclosed provides motorcyclists with an inexpensive accessory that can be used to customize motorcycles.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A handlebar riser assembly and accessory article, comprising:
a first and second riser bar comprising a lower portion, an upper portion, and an elongated length;
said upper portion further comprising a removable clamping portion;
said clamping portion being operably fastened to said upper portion;
said clamping portion and said upper portion forming a handlebar aperture configured to clamp around an exterior surface of an elongated handlebar;
said lower portion of each riser bar configured to be supported by a triple tree;
a first and second elongated coil spring having an open inner diameter;
said open inner diameter of each coil spring sized to receive one of said riser bars therethrough.

2) The handlebar riser assembly and accessory article of claim 1, further comprising:
said first and second elongated coil spring having an upper end and a lower end comprising a flat coil;
a spring perch disposed along each riser bar below said upper portion;
each spring perch supporting the upper end of one of said first and second elongated coil spring.

3) The handlebar riser assembly and accessory article of claim 1, further comprising:
said first and second elongated coil spring having an upper end and a lower end comprising a flat coil;
a pair of spring perches disposed along each riser bar, said spring perches disposed above and below each spring.

4) The handlebar riser assembly and accessory article of claim 1, further comprising:
said first and second elongated coil spring each having a spring rate that resists movement once installed, while minimizing load imparted on said upper triple tree.

5) A handlebar riser assembly and accessory article, comprising:
a first and second riser bar comprising a lower portion, an upper portion, and an elongated length;
a handlebar member;
said upper portion of each riser bar being affixed to said handlebar member;
said first and second riser bar and said handlebar member being substantially perpendicular to each other;
said first and second riser bar being substantially parallel to one another;
said lower portion of each riser bar configured to be supported by a triple tree;
a first and second elongated coil spring having an open inner diameter;
said open inner diameter of each coil spring sized to receive one of said riser bars therethrough.

6) The handlebar riser assembly and accessory article of claim 5, further comprising:
said first and second elongated coil spring having an upper end and a lower end comprising a flat coil;
a spring perch disposed along each riser bar below said upper portion;
each spring perch supporting the upper end of one of said first and second elongated coil spring.

7) The handlebar riser assembly and accessory article of claim 5, further comprising:
said first and second elongated coil spring having an upper end and a lower end comprising a flat coil;
a pair of spring perches disposed along each riser bar, said spring perches disposed above and below each spring.

8) The handlebar riser assembly and accessory article of claim 5, further comprising:
said first and second elongated coil spring each having a spring rate that resists movement once installed, while minimizing load imparted on said upper triple tree.
